(19) United States
(12) Patent Application Publication
(10) Pub. No.: US 2012/0189956 A1
(43) Pub. Date: Jul. 26, 2012

(54) SOLVENT-FREE TONER PROCESSES

(75) Inventors: Allan K. Chen, Oakville (CA); Santiago Faucher, Oakville (CA); John L. Pawlak, Rochester, NY (US); Joo T. Chung, Webster, NY (US); Shigang S. Qiu, Toronto (CA); Michael S. Hawkins, Cambridge (CA); Edward G. Zwartz, Mississauga (CA); Abdisamed Sheik-Qasim, Ontario (CA); Melanie Lynn Davis, Ontario (CA)

(73) Assignee: XEROX CORPORATION, Norwalk, CT (US)

(21) Appl. No.: 13/014,028

(22) Filed: Jan. 26, 2011

(51) Int. Cl. G03G 9/08

(52) U.S. Cl. 430/137.14; 430/137.21

(57) ABSTRACT

The present disclosure provides processes for producing toners. In embodiments, alkyl or alkyl ether sulfates are used in a solvent-free toner production process as surfactants to provide for higher parent particle charge without adversely affecting particle size, distribution control and circularity of the toner particles. The present disclosure also provides a new formulation and process for the emulsification of polyester resins to form nano-scale particles dispersed in water (latex) without the use of organic solvents by an extrusion process.

### TECHNICAL FIELD

The present disclosure relates to solvent-free processes for producing toners, including ultra low melt toners.

### BACKGROUND

Toner blends containing crystalline or semi-crystalline polyester resins with an amorphous resin have recently been shown to provide very desirable ultra low melt fusing, which is important for both high-speed printing and lower fuser power consumption. These types of toners containing crystalline polyesters have been demonstrated suitable for both emulsion aggregation (EA) toners, and in conventional jetted toners. Combinations of amorphous and crystalline polyesters may provide toners with relatively low-melting point characteristics (sometimes referred to as low-melt, ultra low melt, or ULM), which allows for more energy-efficient and faster printing.

Emulsion aggregation/coalescing processes for the preparation of toners are illustrated in a number of patents, such as U.S. Pat. Nos. 5,290,654, 5,278,020, 5,308,734, 5,344,738, 6,416,920, 6,576,389, 6,593,049, 6,743,559, 6,756,176, 6,830,860, 7,029,817, and 7,329,476, and U.S. Patent Application Publication Nos. 2006/0216626, 2008/0107990, 2008/0236446, and 2009/0047593. The disclosures of each of the foregoing patents and publications are hereby incorporated by reference in their entirety.

Polyester toners have been prepared utilizing amorphous and crystalline polyester resins as illustrated, for example, in U.S. Patent Application Publication No. 2008/0153027, the disclosure of which is hereby incorporated by reference in its entirety. The incorporation of these polyesters into the toner requires that they first be formulated into emulsions prepared by solvent containing batch processes, for example solvent flash emulsification and/or solvent-based phase inversion emulsification (PIE), which are both time and energy-consuming. In both cases, large amounts of organic solvents, such as ketones or alcohols, have been used to dissolve the resins, which may require subsequent energy intensive distillation to form the latexes, and are not environmentally friendly.

Solventless latex emulsions have been formed in either a batch or extrusion process through the addition of a neutralizing solution, a surfactant solution and water to a thermally softened resin as illustrated, for example, in U.S. Patent Application Publications Serial Nos. 2009/0246680 and 2009/0208864, the disclosures of each of which are hereby incorporated by reference in their entirety. Toners formed with solvent-free processes utilizing some surfactants including alkyldiphenyloxide disulfonates, may have a low triboelectric charge. In addition, the surfactant may be hard to remove from the toner particles at the end of the process.

Improved processes for the preparation of polymer latexes suitable for use in a toner remain desirable.

### SUMMARY

The present disclosure provides processes for producing toner particles and toners produced by such processes. In embodiments, a process of the present disclosure includes forming a pre-blend mixture by optionally contacting at least one amorphous polyester resin with an optional plasticizer; neutralizing the pre-blend mixture with a neutralizing agent to form a neutralized pre-blend mixture; contacting the neutralized pre-blend mixture with a surfactant selected from the group consisting of alkyl sulfates, alkyl ether sulfates, and combinations thereof; melt-mixing the pre-blend mixture; contacting the melt-mixed mixture with de-ionized water to form an oil in water emulsion possessing a latex; and recovering the latex.

In other embodiments, a process of the present disclosure includes forming a resin mixture by optionally contacting at least one amorphous polyester resin with an optional plasticizer in a first section of an extruder; neutralizing the resin mixture in a second section of the extruder with a neutralizing agent to form a neutralized resin mixture; contacting the neutralized resin mixture with a surfactant in the extruder, the surfactant selected from the group consisting of alkyl sulfates, alkyl ether sulfates, and combinations thereof; melt-mixing the resin mixture in the extruder; contacting the melt-mixed mixture with de-ionized water to form an oil in water emulsion in the extruder; recovering the emulsion from the extruder; contacting the emulsion with an optional crystalline resin, an optional colorant, and an optional wax to form a second mixture; aggregating the mixture to form particles; adjusting the pH of the mixture to from about 6.8 to about 8 to stop growth of the particles; coalescing the particles at a pH from about 6.5 to about 7.5 to form toner particles; and recovering the toner particles.

In yet other embodiments, a process of the present disclosure includes forming a resin mixture by contacting at least one polyester resin with an optional crystalline resin and an optional plasticizer in an extruder; neutralizing the resin mixture in the extruder with a neutralizing agent to form a neutralized resin mixture; contacting the neutralized resin mixture in the extruder with a surfactant selected from the group consisting of sodium hexyl sulfate, sodium octyl sulfate, sodium decyl sulfate, sodium dodecyl sulfate, sodium tridecyl sulfate, sodium tertadecyl sulfate, sodium hexadecyl sulfate, sodium octyl decyl sulfate, sodium lauryl sulfate, sodium myristyl sulfate, sodium palmityl sulfate, sodium stearyl sulfate, sodium oleylic sulfate, sodium hexyl ether sulfate, sodium octyl ether sulfate, sodium decyl ether sulfate, sodium dodecyl ether sulfate, sodium tridecyl ether sulfate, sodium tertadecyl ether sulfate, sodium hexadecyl ether sulfate, sodium octyl decyl ether sulfate, sodium laureth sulfate, sodium myreth sulfate, sodium palmeth sulfate, sodium pareth sulfate, sodium steareth sulfate, sodium oleyl ether sulfate, and combinations thereof; melt-mixing the resin mixture in the extruder; contacting the melt-mixed mixture with de-ionized water in the extruder to form an oil in water emulsion; recovering the emulsion from the extruder; contacting the emulsion with an optional crystalline resin, an optional colorant, and an optional wax to form a second mixture; aggregating the mixture to form particles; adjusting the pH of the mixture to from about 6.8 to about 8 to stop growth of the particles; coalescing the particles at a pH from about 6.5 to about 7.5 to form toner particles; and recovering the toner particles.

### BRIEF DESCRIPTION OF DRAWINGS

Various embodiments of the present disclosure will be described herein below with reference to the figures wherein:

FIG. 1 is a schematic diagram of an extruder for preparation of a resin latex according to embodiments of the present disclosure;

FIG. 2 is a graph depicting gloss as a function of fusing temperature of a toner produced in accordance with the present disclosure treated with sodium lauryl sulfate, compared with the same toner lacking sodium lauryl sulfate used as a control; and

FIG. 3 is a graph depicting crease area as a function of fusing temperature of a toner produced in accordance with the present disclosure treated with sodium lauryl sulfate, compared with the same toner lacking sodium lauryl sulfate used as a control.

### DETAILED DESCRIPTION

The present disclosure provides for the use of alkyl sulfates or alkyl ether sulfates as surfactants in a solvent-free process for the preparation of ultra-low melt polyester toners. Alkyl sulfate and alkyl ether sulfate surfactants provide for higher parent particle charge without adversely affecting other properties of toner particles, including particle size, and circularity. The present disclosure also provides a new formulation and process for the emulsification of polyester resins to form nano-scale particles dispersed in water (latex) without the use of organic solvents by an extrusion process.

As noted above, the latex of the present disclosure and the process for its production are solvent-free and, therefore, there are no traces of solvent present in the latex, as none are used for their production. The resulting emulsion may then be used for forming a toner. In embodiments, the process for producing the emulsion may be a continuous process.

In embodiments, a process of the present disclosure, which emulsifies a polyester resin into latex, includes the following: blending the polyester resin with a neutralizer such as sodium hydroxide (NaOH), potassium hydroxide (KOH), sodium carbonate (NaCO₃), piperazine, or other suitable inorganic or organic base to form a mixture; melt mixing the above mixture in an extruder; emulsifying the melt mixture by injecting de-ionized water into the extruder and/or an aqueous alkyl sulfate surfactant solution, such as sodium octyl sulfate (SOS), sodium dodecyl sulfate (SDS) or sodium lauryl sulfate (SLS), or an aqueous alkyl ether sulfate surfactant solution, such as sodium laureth sulfate also known as sodium lauryl ether sulfate or sodium myreth sulfate also known as sodium myristyl ether sulfate; and diluting the mixture with de-ionized water to form a stable, small particle oil in water latex emulsion. In other embodiments, the aqueous base and surfactant solutions can be added to the melt-mixed polyester resin, then additional water can be added later to dilute the mixture to form a stable, small particle latex emulsion.

The desired properties of the emulsion (particle size and solids content) can be achieved by adjusting the concentration of the surfactant and neutralizer. The quality of the emulsion can be affected by process parameters such as extruder speed, material feed rate, extruder temperature profile, and injection nozzle position. The process of the present disclosure may be continuous, thereby enhancing the efficiency of the process.

### Resins

Toners of the present disclosure may include any polyester latex resin suitable for use in forming a toner. Such resins, in turn, may be made of any suitable monomer.

In embodiments, the polymer utilized to form the resin may be a polyester resin. Suitable polyester resins include, for example, sulfonated, non-sulfonated, crystalline, amorphous, combinations thereof, and the like. The polyester resins may be linear, branched, combinations thereof, and the like. Polyester resins may include, in embodiments, those resins described in U.S. Pat. Nos. 6,593,049 and 6,756,176, the disclosures of each of which are hereby incorporated by reference in their entirety. Suitable resins may also include a mixture of an amorphous polyester resin and a crystalline polyester resin as described in U.S. Pat. No. 6,830,860, the disclosure of which is hereby incorporated by reference in its entirety.

In embodiments, a resin utilized in forming a toner may include an amorphous polyester resin. In embodiments, the resin may be a polyester resin formed by reacting a diol with a diacid or diester in the presence of an optional catalyst.

Examples of organic diols selected for the preparation of amorphous resins include aliphatic diols with from about 2 to about 36 carbon atoms, such as 1,2-ethanediol, 1,3-propanediol, 1,4-butanediol, 1,5-pentanediol, 1,6-hexanediol, 2,2-dimethylpropanediol, 2,2,3-trimethylhexanediol, 1,7-heptanediol, 1,8-octanediol, 1,9-nonanediol, 1,10-decanediol, 1,12-dodecanediol, and the like; bis(hydroxyethyl)-bisphenol A, bis(2-hyroxypropyl)-bisphenol A, 1,4-cyclohexanedimethanol, 1,3-cyclohexanedimethanol, xylenedimethanol, cyclohexanediol, diethylene glycol, bis(2-hydroxyethyl)oxide, dipropylene glycol, dibutylene, and mixtures thereof; alkali sulfo-aliphatic dials such as sodio 2-sulfo-1,2-ethanediol, lithio 2-sulfo-1,2-ethanediol, potassio 2-sulfo-1,2-ethanediol, sodio 2-sulfa-1,3-propanediol, lithio 2-sulfo-1,3-propanediol, potassio 2-sulfo-1,3-propanediol, mixture thereof, and the like. The aliphatic diol is, for example, selected in an amount of from about 45 to about 52 mole percent of the resin, and the alkali sulfo-aliphatic diol can be selected in an amount of from about 1 to about 10 mole percent of the resin.

Examples of diacid or diesters selected for the preparation of the amorphous polyester include dicarboxylic acids or diesters selected from the group consisting of terephthalic acid, phthalic acid, isophthalic acid, fumaric acid, maleic acid, itaconic acid, succinic acid, succinic anhydride, dodecylsuccinic acid, dodecylsuccinic anhydride, dodecenylsuccinic acid, dodecenylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, dimethyl dodecenylsuccinate, and mixtures thereof. The organic diacid or diester is selected, for example, from about 45 to about 52 mole percent of the resin.

Examples of suitable polycondensation catalyst for either the amorphous polyester resin include tetraalkyl titanates, dialkyltin oxide such as dibutyltin oxide, tetraalkyltin such as dibutyltin dilaurate, dialkyltin oxide hydroxide such as butyltin oxide hydroxide, aluminum alkoxides, alkyl zinc, dialkyl zinc, zinc oxide, stannous oxide, stannous alkylnoates such as stannous octanoate (tin 2-ethylhexanoate) and the like, or mixtures thereof; and which catalysts are selected in amounts of, for example, from about 0.01 mole percent to about 5 mole percent based on the starting diacid or diester used to generate the polyester resin.

In embodiments, suitable amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), a copoly(propoxylated bisphenol A co-fumarate)-copoly(propoxylated bisphenol A co-terephthalate), a terpoly (propoxylated bisphenol A co-fumarate)-terpoly(propoxylated bisphenol A co-terephthalate)-terpoly-(propoxylated bisphenol A co-dodecylsuccinate), and combinations thereof. In embodiments, the amorphous resin utilized in the core may be linear.

In embodiments, a suitable amorphous resin may include alkoxylated bisphenol A fumarate/terephthalate based polyesters and copolyester resins. In embodiments, a suitable amorphous polyester resin may be a copoly(propoxylated bisphenol A co-fumarate)-copoly(propoxylated bisphenol A co-terephthalate) resin having the following formula (I):

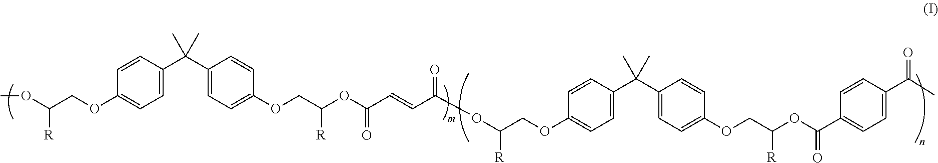

wherein R may be hydrogen or a methyl group, and m and n represent random units of the copolymer and m may be from about 2 to 10, and n may be from about 2 to 10.

An example of a linear copoly(propoxylated bisphenol A co-fumarate)-copoly(propoxylated bisphenol A co-terephthalate) which may be utilized as a latex resin is available under the trade name SPARII from Resana S/A Industrias Quimicas, Sao Paulo Brazil. Other suitable linear resins include linear polyester resins including dodecylsuccinic anhydride, terephthalic acid, and alkyloxylated bisphenol A, which are disclosed in U.S. Pat. Nos. 4,533,614, 4,957,774 and 4,533,614. The disclosures of each of the foregoing patents are hereby incorporated by reference in their entirety. Other propoxylated bisphenol A fumarate resins that may be utilized and are commercially available include GTU-FC 115 from Kao Corporation, Japan, and EM181635 from Reichhold, Research Triangle Park, North Carolina and the like.

In embodiments, the amorphous polyester resin may be a saturated or unsaturated amorphous polyester resin. Illustrative examples of saturated and unsaturated amorphous polyester resins selected for the process and particles of the present disclosure include any of the various amorphous polyesters, such as polyethylene-terephthalate, polypropylene-terephthalate, polybutylene-terephthalate, polypentylene-terephthalate, polyhexylene-terephthalate, polyheptadene-terephthalate, polyoctalene-terephthalate, polyethylene-isophthalate, polypropylene-isophthalate, polybutylene-isophthalate, polypentylene-isophthalate, polyhexylene-isophthalate, polyheptadene-isophthalate, polyoctalene-isophthalate, polyethylene-sebacate, polypropylene sebacate, polybutylene-sebacate, polyethylene-adipate, polypropylene-adipate, polybutylene-adipate, polypentylene-adipate, polyhexylene-adipate, polyheptadene-adipate, polyoctalene-adipate, polyethylene-glutarate, polypropylene-glutarate, polybutylene-glutarate, polypentylene-glutarate, polyhexylene-glutarate, polyheptadene-glutarate, polyoctalene-glutarate polyethylene-pimelate, polypropylene-pimelate, polybutylene-pimelate, polypentylene-pimelate, polyhexylene-pimelate, polyheptadene-pimelate, poly(ethoxylated bisphenol A-fumarate), poly(ethoxylated bisphenol A-succinate), poly(ethoxylated bisphenol A-adipate), poly(ethoxylated bisphenol A-glutarate), poly(ethoxylated bisphenol A-terephthalate), poly(ethoxylated bisphenol A-isophthalate), poly(ethoxylated bisphenol A-dodecenylsuccinate), poly(propoxylated bisphenol A-fumarate), poly(propoxylated bisphenol A-succinate), poly(propoxylated bisphenol A-adipate), poly(propoxylated bisphenol A-glutarate), poly(propoxylated bisphenol A-terephthalate), poly(propoxylated bisphenol A-isophthalate), poly(propoxylated bisphenol A-dodecenylsuccinate), SPAR (Dixie Chemicals), BECKOSOL (Reichhold Inc), ARAKOTE (Ciba-Geigy Corporation), HETRON (Ashland Chemical), PARAPLEX (Rohm & Haas), POLYLITE (Reichhold Inc), PLASTHALL & Haas), CYGAL (American Cyanamide), ARMCO (Armco Composites), ARPOL (Ashland Chemical), CELANEX (Celanese Eng), RYNITE (DuPont), STYPOL (Freeman Chemical Corporation) and combinations thereof. The resins can also be functionalized, such as carboxylated, sulfonated, or the like, and particularly such as sodio sulfonated, if desired.

The amorphous polyester resin may be a branched resin. As used herein, the terms “branched” or “branching” includes branched resin and/or cross-linked resins. Branching agents for use in forming these branched resins include, for example, a multivalent polyacid such as 1,2,4-benzene-tricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylene-carboxylpropane, tetra(methylene-carboxyl)methane, and 1,2,7,8-octanetetracarboxylic acid, acid anhydrides thereof, and lower alkyl esters thereof, 1 to about 6 carbon atoms; a multivalent polyol such as sorbitol, 1,2,3,6-hexanetetrol, 1,4-sorbitane, pentaerythritol, dipentaerythritol, tripentaerythritol, sucrose, 1,2,4-butanetriol, 1,2,5-pentatriol, glycerol, 2-methylpropanetriol, 2-methyl-1,2,4-butanetriol, trimethylolethane, trimethylolpropane, 1,3,5-trihydroxymethylbenzene, mixtures thereof, and the like. The branching agent amount selected is, for example, from about 0.1 to about 5 mole percent of the resin.

Linear or branched unsaturated polyesters selected for reactions include both saturated and unsaturated diacids (or anhydrides) and dihydric alcohols (glycols or diols). The resulting unsaturated polyesters are reactive (for example, crosslinkable) on two fronts: (i) unsaturation sites (double bonds) along the polyester chain, and (ii) functional groups such as carboxyl, hydroxy, and the like groups amenable to acid-base reactions. Typical unsaturated polyester resins may be prepared by melt polycondensation or other polymerization processes using diacids and/or anhydrides and diols.

In embodiments, a suitable amorphous resin utilized in a toner of the present disclosure may be a low molecular weight amorphous resin, sometimes referred to, in embodiments, as an oligomer, having a weight average molecular weight (Mw) of from about 500 daltons to about 50,000 daltons, in embodiments from about 1,000 daltons to about 30,000 daltons, in other embodiments from about 1,500 daltons to about 20,000 daltons.

The low molecular weight amorphous resin may possess a glass transition temperature (Tg) of from about 60° C. to about 70° C., in embodiments from about 62° C. to about 64° C. These low molecular weight amorphous resins may be referred to, in embodiments, as a high Tg amorphous resin.

The low molecular weight amorphous resin may possess a softening point of from about 105° C. to about 118° C., in embodiments from about 107° C. to about 109° C.

In other embodiments, an amorphous resin utilized in forming a toner of the present disclosure may be a high molecular weight amorphous resin. As used herein, the high molecular weight amorphous polyester resin may have, for example, a number average molecular weight (Mₙ), as measured by gel permeation chromatography (GPC) of, for example, from about 1,000 to about 10,000, in embodiments from about 2,000 to about 9,000, in embodiments from about 3,000 to about 8,000, and in embodiments from about 6,000 to about 7,000. The weight average molecular weight (M_{w}) of the resin is greater than 45,000, for example, from about 45,000 to about 150,000, in embodiments from about 50,000 to about 100,000, in embodiments from about 63,000 to about 94,000, and in embodiments from about 68,000 to about 85,000, as determined by GPC using a polystyrene standard. The polydispersity index (PD) is above about 4, such as, for example, greater than about 4, in embodiments from about 4 to about 20, in embodiments from about 5 to about 10, and in embodiments from about 6 to about 8, as measured by GPC versus standard polystyrene reference resins. The PD index is the ratio of the weight-average molecular weight (M_{w}) and the number-average molecular weight (Mₙ). The low molecular weight amorphous polyester resins may have an acid value of from about 8 to about 20 mg KOH/g, in embodiments from about 9 to about 16 mg KOH/g, and in embodiments from about 11 to about 15 mg KOH/g. The high molecular weight amorphous polyester resins, which are available from a number of sources, can possess various melting points of, for example, from about 30° C. to about 140° C., in embodiments from about 75° C. to about 130° C., in embodiments from about 100° C. to about 125° C., and in embodiments from about 115° C. to about 124° C.

High molecular weight amorphous resins may possess a glass transition temperature of from about 53° C. to about 59° C., in embodiments from about 54.5° C. to about 57° C. These high molecular weight amorphous resins may be referred to, in embodiments, as a low Tg amorphous resin.

In embodiments, a combination of low Tg and high Tg amorphous resins may be used to form a toner of the present disclosure. The ratio of low Tg amorphous resin to high Tg amorphous resin may be from about 0:100 to about 100:0, in embodiments from about 30:70 to about 50:50. In embodiments, the combined amorphous resins may have a melt viscosity of from about 10 to about 1,000,000 Pa*S at about 130° C., in embodiments from about 50 to about 100,000 Pa*S.

The amorphous resin is generally present in the toner composition in various suitable amounts, such as from about 60 to about 90 weight percent, in embodiments from about 50 to about 65 weight percent, of the toner or of the solids.

In embodiments, the toner composition may include at least one crystalline resin. As used herein, “crystalline” refers to a polyester with a three dimensional order. “Semicrystalline resins” as used herein refers to resins with a crystalline percentage of, for example, from about 10 to about 90%, in embodiments from about 12 to about 70%. Further, as used herein, “crystalline polyester resins” and “crystalline resins” encompass both crystalline resins and semicrystalline resins, unless otherwise specified.

In embodiments, the crystalline polyester resin is a saturated crystalline polyester resin or an unsaturated crystalline polyester resin.

For forming a crystalline polyester, suitable organic diols include aliphatic diols having from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, ethylene glycol, combinations thereof, and the like. The aliphatic diol may be, for example, selected in an amount of from about 40 to about 60 mole percent, in embodiments from about 42 to about 55 mole percent, in embodiments from about 45 to about 53 mole percent of the resin.

Examples of organic diacids or diesters selected for the preparation of the crystalline resins include oxalic acid, succinic acid, glutaric acid, adipic acid, suberic acid, azelaic acid, fumaric acid, maleic acid, dodecanedioic acid, sebacic acid, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof, and combinations thereof. The organic diacid may be selected in an amount of, for example, in embodiments from about 40 to about 60 mole percent, in embodiments from about 42 to about 55 mole percent, in embodiments from about 45 to about 53 mole percent.

Examples of crystalline polyester resins include, but are not limited to, poly(ethylene-adipate), polypropylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), alkali copoly(5-sulfoisophthaloyl)-copoly(ethylene-adipate), poly(decylene-sebacate), poly(decylene-decanoate), poly-(ethylene-decanoate), poly-(ethylene-dodecanoate), poly(nonylene-sebacate), poly(nonylene-decanoate), poly(nonylene-dodecanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), and combinations thereof. The crystalline resin may be present, for example, in an amount of from about 5 to about 50 percent by weight of the toner components, in embodiments from about 10 to about 35 percent by weight of the toner components.

The crystalline polyester resins, which are available from a number of sources, may possess various melting points of, for example, from about 30° C. to about 120° C., in embodiments from about 50° C. to about 90° C. The crystalline resins may have, for example, a number average molecular weight (Mₙ), as measured by gel permeation chromatography (GPC) of, for example, from about 1,000 to about 50,000, in embodiments from about 2,000 to about 25,000, in embodiments from about 3,000 to about 15,000, and in embodiments from about 6,000 to about 12,000. The weight average molecular weight (M_{w}) of the resin is 50,000 or less, for example, from about 2,000 to about 50,000, in embodiments from about 3,000 to about 40,000, in embodiments from about 10,000 to about 30,000 and in embodiments from about 21,000 to about 24,000, as determined by GPC using polystyrene standards. The molecular weight distribution (M_{w}/Mₙ) of the crystalline resin is, for example, from about 2 to about 6, in embodiments from about 3 to about 4. The crystalline polyester resins may have an acid value of about 2 to about 20 mg KOH/g, in embodiments from about 5 to about 15 mg KOH/g, and in embodiments from about 8 to about 13 mg KOH/g. The acid value (or neutralization number) is the mass of potassium hydroxide (KOH) in milligrams that is required to neutralize one gram of the crystalline polyester resin.

Suitable crystalline polyester resins include those disclosed in U.S. Pat. No. 7,329,476 and U.S. Patent Application Publication Nos. 2006/0216626, 2008/0107990, 2008/0236446 and 2009/0047593, each of which is hereby incorporated by reference in their entirety. In embodiments, a suitable crystalline resin may include a resin composed of ethylene glycol or nonanediol and a mixture of dodecanedioic acid and fumaric acid co-monomers with the following formula (II):

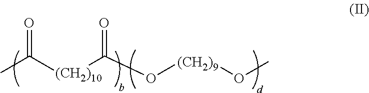

wherein b is from about 5 to about 2000 and d is from about 5 to about 2000.

If semicrystalline polyester resins are employed herein, the semicrystalline resin may include poly(3-methyl-1-butene), poly(hexamethylene carbonate), poly(ethylene-p-carboxy phenoxy-butyrate), poly(ethylene-vinyl acetate), poly(docosyl acrylate), poly(dodecyl acrylate), poly(octadecyl acrylate), poly(octadecyl methacrylate), poly(behenylpolyethoxyethyl methacrylate), poly(ethylene adipate), poly(decamethylene adipate), poly(decamethylene azelaate), poly(hexamethylene oxalate), poly(decamethylene oxalate), poly(ethylene oxide), poly(propylene oxide), poly(butadiene oxide), poly(decamethylene oxide), poly(decamethylene sulfide), poly(decamethylene disulfide), poly(ethylene sebacate), poly(decamethylene sebacate), poly(ethylene suberate), poly(decamethylene succinate), poly(eicosamethylene malonate), poly(ethylene-p-carboxy phenoxy-undecanoate), poly(ethylene dithionesophthalate), poly(methyl ethylene terephthalate), poly(ethylene-p-carboxy phenoxy-valerate), poly(hexamethylene-4,4′-oxydibenzoate), poly(10-hydroxy capric acid), poly(isophthalaldehyde), poly(octamethylene dodecanedioate), poly(dimethyl siloxane), poly(dipropyl siloxane), poly(tetramethylene phenylene diacetate), poly(tetramethylene trithiodicarboxylate), poly(trimethylene dodecane dioate), poly(m-xylene), poly(p-xylylene pimelamide), and combinations thereof.

A crystalline polyester resin in a toner particle of the present disclosure may be present in an amount of from about 1 to about 15 percent by weight, in embodiments from about 5 to about 10 percent by weight, and in embodiments from about 6 to about 8 percent by weight, of the toner particles (that is, toner particles exclusive of external additives and water).

As noted above, in embodiments a toner of the present disclosure may also include at least one high molecular weight branched or cross-linked amorphous polyester resin. This high molecular weight resin may include, in embodiments, for example, a branched amorphous resin or amorphous polyester, a cross-linked amorphous resin or amorphous polyester, or mixtures thereof, or a non-cross-linked amorphous polyester resin that has been subjected to cross-linking. In accordance with the present disclosure, from about 1% by weight to about 100% by weight of the high molecular weight amorphous polyester resin may be branched or cross-linked, in embodiments from about 2% by weight to about 50% by weight of the higher molecular weight amorphous polyester resin may be branched or cross-linked.

In embodiments, toner particles of the present disclosure may have a core including from about 8% by weight to about 15% by weight of a low molecular weight, high Tg, amorphous resin, in embodiments from about 9% by weight to about 12% by weight of a low molecular weight, high Tg, amorphous resin, in embodiments about 10.85% by weight of a low molecular weight, high Tg, resin, in combination with from about 36% by weight to about 44% by weight of a high molecular weight, low Tg, amorphous resin, in embodiments from about 37% by weight to about 43% by weight of a high molecular weight, low Tg, amorphous resin, in embodiments about 38.85% by weight of a high molecular weight, low Tg, resin. Such toner particles may also include a shell including from about 25% by weight to about 55% by weight of a low molecular weight, high Tg, amorphous resin, in embodiments from about 26% by weight to about 35% by weight of a low molecular weight, high Tg, amorphous resin, in embodiments about 28% by weight of the low molecular weight, high Tg, resin, optionally in combination with from about 25% by weight to about 55% by weight of a high molecular weight, low Tg, amorphous resin, in embodiments from about 27% by weight to about 40% by weight of a high molecular weight, low Tg, amorphous resin, in embodiments from about 30% by weight to about 35% by weight of a high molecular weight, low Tg, amorphous resin.

As noted above, in embodiments, the toners may be formed by emulsion aggregation methods. Utilizing such methods, the resin may be present in a resin emulsion, which may then be combined with other components and additives to form a toner of the present disclosure.

### Toner

The resin described above may be utilized to form toner compositions. Such toner compositions may include optional colorants, waxes, and other additives. Toners may be formed utilizing any method within the purview of those skilled in the art.

### Plasticizer

In embodiments, a plasticizer may be added to the resins described above. The plasticizer may be used to soften the resin to a viscosity suitable for passage through an extruder. The softened resin may be sufficiently viscous so as to not be free-flowing at room temperature, but sufficiently pliable to be mixed by the extruder. The complex viscosity of the softened resin, sometimes referred to herein, in embodiments, as a pre-blend mixture, may be from about 10 Pa*S to about 1,000 Pa*S at about 130° C., in embodiments, from about 50 Pa*S to about 500 Pa*S. The complex viscosity of the resin pre-blend mixture can be measured using any suitable rheometer. For example, a 25 mm sample disc can be prepared by molding about 0.5 grams of pre-blend mixture under a pressure of about 10,000 lbs and the complex viscosity response at various temperature and shear rates can be determined using a parallel plate rheometer such as a Rheometric Scientific Corporation Model ARES.

In embodiments, waxes may be used as plasticizers for softening the resin. The wax may be provided in a wax dispersion, which may include a single type of wax or a mixture of two or more different waxes. When included, the wax may be present in an amount of, for example, from about 1% by weight to about 25% by weight of the resin, in embodiments from about 5% by weight to about 20% by weight of the resin.

Waxes that may be utilized include waxes having, for example, a weight average molecular weight of from about 500 to about 20,000, in embodiments from about 1,000 to about 10,000. Suitable plasticizer waxes include ester waxes obtained from higher fatty acids and higher alcohols, such as stearyl stearate and behenyl behenate; ester waxes obtained from higher fatty acids and monovalent or multivalent lower alcohols, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Other suitable plasticizer waxes include functionalized waxes having amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated and amide waxes, such as aliphatic polar amide functionalized waxes; aliphatic waxes including esters of hydroxylated unsaturated fatty acids, for example MICROSPERSION 19™ available from Micro Powder Inc., imides, esters, quaternary amines, carboxylic acids or acrylic polymer emulsions, for example JONCRYL 74™, 89™, 130™, 537™, and 538™, all available from SC Johnson Wax, and chlorinated polypropylenes and polyethylenes, available from Allied Chemical, Petrolite Corporation, and/or SC Johnson Wax. Mixtures and combinations of the foregoing waxes may also be used in embodiments.

In embodiments, if the polyester resin is an amorphous resin, a crystalline polyester resin may be used as a plasticizer, which lowers the softening temperature of the amorphous resin such that, at temperatures near the boiling point of water, the viscosity of the melt mix is low enough to form an emulsion.

### Neutralizing Agent

In embodiments, the resin may be pre-blended with a weak base or neutralizing agent. In embodiments, the base may be contacted with the resin as a solid or in an aqueous solution. The resin and the neutralizing agent may be simultaneously fed through a co-feeding process, which may accurately control the feed rate of both the base and the resin into the extruder throughout the process, and which may then be melt-mixed followed by emulsification. Utilizing this process allows for control of the base concentration and a more efficient process. Co-feeding may allow for process repeatability and stability, and lower initial start-up waste.

In embodiments, the neutralizing agent may be used to neutralize acid groups in the resins, so a neutralizing agent herein may also be referred to as a “basic neutralization agent.” Any suitable basic neutralization reagent may be used in accordance with the present disclosure. In embodiments, suitable basic neutralization agents may include both inorganic basic agents and organic basic agents. Suitable basic agents may include ammonium hydroxide, potassium hydroxide, sodium hydroxide, sodium carbonate, sodium bicarbonate, lithium hydroxide, potassium carbonate, potassium bicarbonate, combinations thereof, and the like. Suitable basic agents may also include monocyclic compounds and polycyclic compounds having at least one nitrogen atom, such as, for example, primary and secondary aliphatic and aromatic amines, examples of which include aziridines, azetidines, piperazines, piperidines, pyridines, bipyridines, terpyridines, dihydropyridines, morpholines, N-alkylmorpholines, 1,4-diazabicyclo[2.2.2]octanes, 1,8-diazabicycloundecanes, 1,8-diazabicycloundecenes, dimethylated pentylamines, trimethylated pentylamines, pyrimidines, pyrroles, pyrrolidines, pyrrolidinones, indoles, indolines, indanones, benzindazones, imidazoles, benzimidazoles, imidazolones, imidazolines, oxazoles, isoxazoles, oxazolines, oxadiazoles, thiadiazoles, carbazoles, quinolines, isoquinolines, naphthyridines, triazines, triazoles, tetrazoles, pyrazoles, pyrazolines, and combinations thereof. In embodiments, the monocyclic and polycyclic compounds may be unsubstituted or substituted at any carbon position on the ring.

The basic agent may be utilized as a solid such as, for example, sodium hydroxide flakes, so that it is present in an amount of from about 0.001% by weight to 50% by weight of the resin, in embodiments from about 0.01% by weight to about 25% by weight of the resin, in embodiments from about 0.1% by weight to 5% by weight of the resin.

As noted above, the basic neutralization agent may be added to a resin possessing acid groups. The addition of the basic neutralization agent may thus raise the pH of an emulsion including a resin possessing acid groups to a pH of from about 5 to about 12, in embodiments, from about 6 to about 11. The neutralization of the acid groups may, in embodiments, enhance formation of the emulsion.

In embodiments, the process of the present disclosure may include adding a surfactant, before or during the melt-mixing, to the resin at an elevated temperature. In embodiments, a solid surfactant may be co-fed with the resin and the neutralizing agent into the extruder. In embodiments, a solid surfactant may be added to the resin and the neutralizing agent to form a pre-blend mixture prior to melt-mixing. Where utilized, a resin emulsion may include one, two, or more surfactants. The surfactants may be selected from ionic surfactants and nonionic surfactants. Anionic surfactants and cationic surfactants are encompassed by the term “ionic surfactants.” In embodiments, the surfactant may be added as a solid or as a solution with a concentration of from about 5% to about 100% (pure surfactant) by weight, in embodiments, from about 10% to about 95% by weight. In embodiments, the surfactant may be utilized so that it is present in an amount of from about 0.01% to about 20% by weight of the resin, in embodiments, from about 0.1% to about 16% by weight of the resin, in embodiments, from about 1% to about 14% by weight of the resin.

Anionic surfactants which may be utilized include sulfates and sulfonates such as sodium dodecylsulfate (SDS), sodium dodecylbenzene sulfonate (SDBS), sodium lauryl sulfate (SLS), sodium laureth sulfate (SLES) also known as sodium lauryl ether sulfate, sodium myreth sulfate also known as sodium myristyl ether sulfate, sodium dodecylnaphthalene sulfate, dialkyl benzenealkyl sulfates and sulfonates, acids such as abitic acid available from Aldrich, NEOGEN R™, NEOGEN SC™ obtained from Daiichi Kogyo Seiyaku, combinations thereof, and the like. Combinations of these surfactants and any of the foregoing anionic surfactants may be utilized in embodiments.

Examples of the cationic surfactants, which are usually positively charged, include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, MIRAPOL™ and ALKAQUAT™, available from Alkaril Chemical Company, SANIZOL™ (benzalkonium chloride), available from Kao Chemicals, and the like, and mixtures thereof.

Examples of nonionic surfactants that may be utilized for the processes illustrated herein include, for example, polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. Other examples of suitable nonionic surfactants may include a block copolymer of polyethylene oxide and polypropylene oxide, including those commercially available as SYNPERONIC PE/F, in embodiments SYNPERONIC PE/F 108. Combinations of these surfactants and any of the foregoing surfactants may be utilized in embodiments.

In embodiments, anionic surfactants, including alkyl sulfates, such as sodium hexyl sulfate, sodium octyl sulfate, sodium decyl sulfate, sodium dodecyl sulfate, sodium tridecyl sulfate, sodium tertadecyl sulfate, sodium hexadecyl sulfate, sodium octyl decyl sulfate, sodium lauryl sulfate, sodium myristyl sulfate, sodium palmityl sulfate, sodium stearyl sulfate, sodium oleylic sulfate, and combinations thereof, may be used, in amounts from about 1% to about 15% by weight of the resin, in embodiments from about 2% to about 10% by weight of the resin, in embodiments from about 3% to about 5% by weight of the resin.

In embodiments, anionic surfactants, including alkyl ether sulfates, such as sodium hexyl ether sulfate, sodium octyl ether sulfate, sodium decyl ether sulfate, sodium dodecyl ether sulfate, sodium tridecyl ether sulfate, sodium tertadecyl ether sulfate, sodium hexadecyl ether sulfate, sodium octyl decyl ether sulfate, sodium laureth sulfate (sodium lauryl ether sulfate), sodium myreth sulfate (sodium myristyl ether sulfate), sodium palmeth sulfate, sodium pareth sulfate, sodium steareth sulfate (sodium stearyl ether sulfate), sodium oleyl ether sulfate, and combinations thereof, may be used, in amounts from about 1% to about 15% by weight of the resin, in embodiments from about 2% to about 10% by weight of the resin, in embodiments from about 3% to about 5% by weight of the resin.

### Resin Mixture Processing

As noted above, the present process includes melt-mixing a mixture in an extruder at an elevated temperature containing a resin, an optional plasticizer, a solid or aqueous surfactant, and a neutralizing agent. The elevated temperature may be from about 30° C. to about 200° C., in embodiments from about 50° C. to about 150° C., in embodiments from about 70° C. to about 100° C. In embodiments, the process of the present disclosure may be continuous.

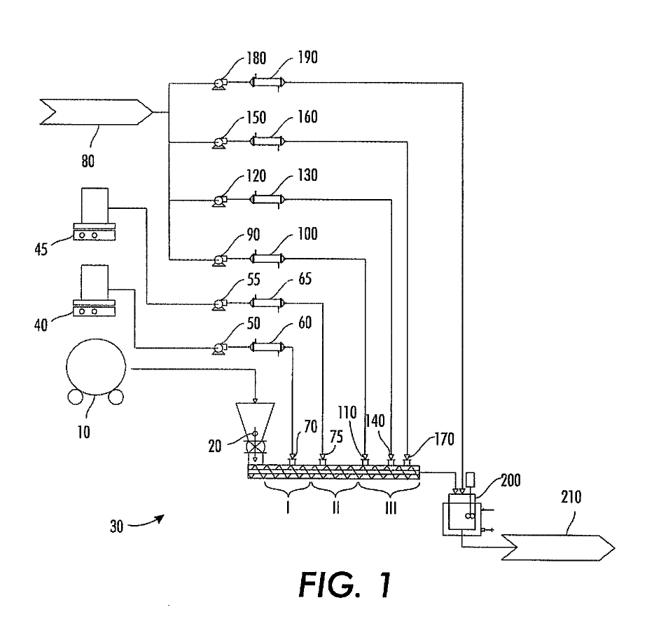

Turning to FIG. 1, melt-mixing of the resin may be conducted in an extruder 30, which may be a twin screw extruder, a kneader such as a Haake mixer, a batch reactor, or any other device capable of intimately mixing viscous materials to create near homogenous mixtures. Stirring, although not necessary, may be utilized to enhance formation of the latex. Any suitable stirring device may be utilized. In embodiments, the stirring may be at from about 10 revolutions per minute (rpm) to about 5,000 rpm, in embodiments from about 20 rpm to about 2,000 rpm, in embodiments from about 50 rpm to about 1,000 rpm. The stirring need not be at a constant speed and may be varied. For example, as the heating of the mixture becomes more uniform, the stirring rate may be increased.

More than one resin may be utilized in forming the latex. As noted above, the resin may be a polyester amorphous resin, a crystalline resin, or a combination thereof. In embodiments, the resin may be an amorphous resin and the elevated temperature may be a temperature above the glass transition temperature of the amorphous resin. In embodiments, the resin may be a crystalline resin and the elevated temperature may be a temperature above the melting point of the crystalline resin. In further embodiments, the resin may be a mixture of amorphous and crystalline resins and the temperature may be above the glass transition temperature of the mixture.

In embodiments, the resin, the plasticizer and the neutralizing agent may be pre-blended prior to melt-mixing. In embodiments, the resin and the plasticizer may be mixed in a tumbler 10 for from about 10 minutes to about 60 minutes, in embodiments from about 15 minutes to about 30 minutes, at a rotor speed of from about 1 rotation per minute (rpm) to about 20 rpm, in embodiments from about 5 rpm to about 15 rpm, to prepare a pre-blend mixture.

The pre-blend resin mixture is fed through a screw feeder 20 coupled to the extruder 30. The pre-blend resin mixture may be co-fed into the extruder 30 with a neutralizing agent in solid form, such as flakes or pellets being fed through a separate feeder (not shown). If the neutralizing agent is used in an aqueous solution, the dissolved neutralizing agent may be pre-mixed with the surfactant and water in a vessel 45 and co-fed through pump 55 to extruder injection port 75 or fed separately to injection port 75. The neutralizing agent may be fed at a rate such that it is at a concentration of about 0.2% by weight to about 5% by weight of the resin, in embodiments, from about 0.4% by weight to about 2% by weight of the resin. Concentration of the components is provided rather than the rates to achieve the desired composition, since flow and feed rates vary with the scale of the processing equipment (e.g., extruder 30).

In embodiments, a solid surfactant may be utilized and co-fed with the resin into the extruder feed hopper. The surfactant may be added to the resin composition before, during, or after melt-mixing and before, during, or after the addition of the neutralizing agent. Alternatively, the surfactant may be in an aqueous solution. More specifically, as the pre-blend resin mixture travels down the extruder 30, a solution of the surfactant may be fed into the extruder's injection port 75, from the vessel 45 via the diaphragm pump 55 and heated via heat exchanger 65. If a solid neutralizing agent is utilized, the water in the surfactant solution activates the neutralizing agent while the surfactant is melt-mixed with the resin to produce a homogeneous mixture of a neutralized resin. The surfactant is fed at a rate such that it is at a concentration of from about 0.5% by weight to about 15% by weight of the resin, in embodiments, from about 2% by weight to about 10% by weight of the resin.

In embodiments, a plasticizer may be injected directly into the extruder 30 to blend the resin and the plasticizer within the extruder 30, thus eliminating the need for pre-blending. The plasticizer may be fed through an extruder injection port 70, from a vessel 40 via a diaphragm pump 50 and heated via heat exchanger 60. The plasticizer may be injected at a rate such that it is at a concentration of about 5% by weight to about 100% by weight of the resin, in embodiments, from about 10% by weight to about 50% by weight of the resin. The injection port 70 may be disposed at a first section I of the extruder 30, which acts as a melting zone, prior to the injection port 75, which supplies the surfactant solution. The injection port 75 may be disposed at a second section II subsequent to the first section, such that the surfactant is added to the mixture after the plasticizer has been mixed with the resin in the extruder 30. In embodiments, the injection ports 70 and 75 may be disposed at the same section, e.g., first section, in the extruder 30 such that the plasticizer and surfactant are fed simultaneously.

### Emulsion Formation

Once the resin, plasticizer, neutralizing agent and surfactant are melt-mixed, the resulting dispersion mixture may be contacted with water to form an oil in water latex emulsion. For example, de-ionized water (DIW) may be added to form a latex with a solids content of from about 5% to about 50%, in embodiments, of from about 10% to about 40%. In embodiments, water temperatures may be from about 20° C. to about 100° C., in embodiments, from about 60° C. to about 95° C.

Contact between the water and the resin mixture may be achieved via water injection ports into the extruder. As shown in FIG. 1, as the melt-mixed resin mixture travels down the extruder 30, pre-heated, DIW may be added at three subsequent ports 110, 140, and 170 at section III of the extruder 30. DIW may be stored in a tank 80 and be fed to the extruder's injection ports 110, 140, and 170 via diaphragm pumps 90, 120, and 150. The DIW is heated via heat exchangers 100, 130, and 160, respectively.

Addition of water is advantageous so that the formation of an oil in water emulsion may be gradual, ensuring that the materials continue to mix rather than phase separate, and to optimize emulsion formation in the extruder. In embodiments, the ports may inject preheated de-ionized water into the extruder at rates of from about 40 g/min to about 400 g/min, in embodiments, of from about 100 g/min to about 200 g/min, such that the final solids content of the latex emulsion is from about 20% to about 50%, in embodiments, from about 15% to about 35%.

The product exiting from the extruder may include a stream of latex that is collected in a steam traced tank 200 with gentle agitation with additional DIW fed from tank 80 to achieve the desired final product solids content, via diaphragm pump 180 and heated via heat exchanger 190. Once a desired latex is achieved, the latex is discharged as a latex stream 210 for storage and later use in the aggregation/coalescence process described below.

The particle size of the latex emulsion formed can be controlled by the concentration ratio of plasticizer, surfactant and/or neutralizing agent to polyester resin. The solids concentration of the latex may be controlled by the ratio of the resin mixture to water.

In accordance with the present disclosure, it has been found that the processes herein may produce emulsified resin particles.

The emulsified resin particles in the aqueous medium may have a size of about 1500 nm or less, such as from about 10 nm to about 1200 nm, in embodiments from about 30 nm to about 1,000 nm. Particle size distribution of a latex of the present disclosure may be from about 60 nm to about 300 nm, in embodiments, from about 150 nm to about 250 nm. The coarse content of the latex of the present disclosure may be from about 0% by weight to about 5% by weight, in embodiments, from about 0.1% by weight to about 2% by weight. The solids content of the latex of the present disclosure may be from about 5% by weight to about 50% by weight, in embodiments, from about 30% by weight to about 40% by weight.

Following emulsification, additional surfactant, water, and/or neutralizing agent may optionally be added to dilute the emulsion, although this is not required. Following emulsification, the emulsion may be cooled to room temperature, for example from about 20° C. to about 25° C. In embodiments, the latex emulsions of the present disclosure may be utilized to produce toners.

### Toner

Once the resin mixture has been contacted with water to form an emulsion as described above, the resulting resin latex may then be utilized to form a toner by any method within the purview of those skilled in the art. The latex emulsion may be contacted with a colorant, optionally in a dispersion, and other additives to form an ultra low melt toner by a suitable process, in embodiments, an emulsion aggregation and coalescence process.

In embodiments, the optional additional ingredients of a toner composition, including additional resins, such as crystalline resins, colorant, wax, and other additives, may also be added before, during or after melt-mixing the resin to form the latex emulsion of the present disclosure. The additional ingredients may be added before, during or after formation of the latex emulsion. In further embodiments, the colorant may be added before the addition of the surfactant.

### Colorants

As the colorant to be added, various known suitable colorants, such as dyes, pigments, mixtures of dyes, mixtures of pigments, mixtures of dyes and pigments, and the like, may be included in the toner. The colorant may be added in amounts from about 0.1 to about 35 weight percent of the toner, in embodiments from about 1 to about 15 weight percent of the toner, in embodiments from about 3 to about 10 weight percent of the toner.

As examples of suitable colorants, mention may be made of carbon black like REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP604™, NP-608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE 6000, FLEXIVERSE and AQUATONE water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido) phthalocyanine, x-copper phthalocyanine pigment listed in the Color Index as CI 74160, CI Pigment Blue, Pigment Blue 15:3, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange grams (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like.

In embodiments, the colorant may include a pigment, a dye, combinations thereof, carbon black, magnetite, black, cyan, magenta, yellow, red, green, blue, brown, combinations thereof, in an amount sufficient to impart the desired color to the toner. It is to be understood that other useful colorants will become readily apparent based on the present disclosures.

In embodiments, a pigment or colorant may be employed in an amount of from about 1% by weight to about 35% by weight of the toner particles on a solids basis, in embodiments, from about 5% by weight to about 25% by weight.

### Wax

Optionally, a wax may also be combined with the resin and a colorant in forming toner particles. The wax may be provided in a wax dispersion, which may include a single type of wax or a mixture of two or more different waxes. A single wax may be added to toner formulations, for example, to improve particular toner properties, such as toner particle shape, presence and amount of wax on the toner particle surface, charging and/or fusing characteristics, gloss, stripping, offset properties, and the like. Alternatively, a combination of waxes can be added to provide multiple properties to the toner composition.

When included, the wax may be present in an amount of, for example, from about 1% by weight to about 25% by weight of the toner particles, in embodiments from about 5% by weight to about 20% by weight of the toner particles, although the amount of wax can be outside of these ranges.

When a wax dispersion is used, the wax dispersion may include any of the various waxes conventionally used in emulsion aggregation toner compositions. Waxes that may be selected include waxes having, for example, an average molecular weight of from about 500 to about 20,000, in embodiments from about 1,000 to about 10,000. Waxes that may be used include, for example, polyolefins such as polyethylene including linear polyethylene waxes and branched polyethylene waxes, polypropylene including linear polypropylene waxes and branched polypropylene waxes, polyethylene/amide, polyethylenetetrafluoroethylene, polyethylenetetrafluoroethylene/amide, and polybutene waxes such as commercially available from Allied Chemical and Petrolite Corporation, for example POLYWAX™ polyethylene waxes such as commercially available from Baker Petrolite, wax emulsions available from Michaelman, Inc. and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax such as waxes derived from distillation of crude oil, silicone waxes, mercapto waxes, polyester waxes, urethane waxes; modified polyolefin waxes (such as a carboxylic acid-terminated polyethylene wax or a carboxylic acid-terminated polypropylene wax); Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, such as aliphatic polar amide functionalized waxes; aliphatic waxes consisting of esters of hydroxylated unsaturated fatty acids, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents. In embodiments, the waxes may be crystalline or non-crystalline.

In embodiments, the wax may be incorporated into the toner in the form of one or more aqueous emulsions or dispersions of solid wax in water, where the solid wax particle size may be of from about 100 nm to about 300 nm, in embodiments from about 125 nm to about 275 nm.

### Toner Preparation

The toner particles may be prepared by any method within the purview of one skilled in the art. Although embodiments relating to toner particle production are described below with respect to emulsion aggregation processes, any suitable method of preparing toner particles may be used, including chemical processes, such as suspension and encapsulation processes disclosed in U.S. Pat. Nos. 5,290,654 and 5,302,486, the disclosures of each of which are hereby incorporated by reference in their entirety. In embodiments, toner compositions and toner particles may be prepared by aggregation and coalescence processes in which small-size resin particles are aggregated to the appropriate toner particle size and then coalesced to achieve the final toner particle shape and morphology.

In embodiments, toner compositions may be prepared by emulsion aggregation processes, such as a process that includes aggregating a mixture of an optional colorant, an optional wax and any other desired or required additives, and emulsions including the resins described above, optionally in surfactants as described above, and then coalescing the aggregate mixture. A mixture may be prepared by adding a colorant and optionally a wax or other materials, which may also be optionally in a dispersion(s) including a surfactant, to the emulsion, which may be a mixture of two or more emulsions containing the resin. The pH of the resulting mixture may be adjusted by an acid such as, for example, acetic acid, nitric acid or the like. In embodiments, the pH of the mixture may be adjusted to from about 2 to about 5. Additionally, in embodiments, the mixture may be homogenized. If the mixture is homogenized, homogenization may be accomplished by mixing at about 600 to about 6,000 revolutions per minute. Homogenization may be accomplished by any suitable means, including, for example, an IKA ULTRA TURRAX T50 probe homogenizer.

Following the preparation of the above mixture, an aggregating agent may be added to the mixture. Any suitable aggregating agent may be utilized to form a toner. Suitable aggregating agents include, for example, aqueous solutions of a divalent cation or a multivalent cation material. The aggregating agent may be, for example, an inorganic cationic aggregating agent such as polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (Tg) of the resin.

Suitable examples of organic cationic aggregating agents include, for example, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, combinations thereof, and the like.

Other suitable aggregating agents also include, but are not limited to, tetraalkyl titanates, dialkyltin oxide, tetraalkyltin oxide hydroxide, dialkyltin oxide hydroxide, aluminum alkoxides, alkylzinc, dialkyl zinc, zinc oxides, stannous oxide, dibutyltin oxide, dibutyltin oxide hydroxide, tetraalkyl tin, combinations thereof, and the like. Where the aggregating agent is a polyion aggregating agent, the agent may have any desired number of polyion atoms present. For example, in embodiments, suitable polyaluminum compounds have from about 2 to about 13, in embodiments, from about 3 to about 8, aluminum ions present in the compound.

The aggregating agent may be added to the mixture utilized to form a toner in an amount of, for example, from about 0% to about 10% by weight, in embodiments from about 0.2% to about 8% by weight, in embodiments from about 0.5% to about 5% by weight, of the resin in the mixture. This should provide a sufficient amount of agent for aggregation.

The particles may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation thus may proceed by maintaining the elevated temperature, or slowly raising the temperature to, for example, from about 40° C. to about 100° C., and holding the mixture at this temperature for a time of from about 0.5 hours to about 6 hours, in embodiments from about hour 1 to about 5 hours, while maintaining stirring, to provide the aggregated particles. Once the predetermined desired particle size is reached, then the growth process is halted.

The growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example of from about 40° C. to about 90° C., in embodiments from about 45° C. to about 80° C., which may be below the glass transition temperature of the resin as discussed above.

Once the desired final size of the toner particles is achieved, the pH of the mixture may be adjusted with a base to a value of from about 3 to about 10, in embodiments from about 5 to about 9, in further embodiments from about 6.8 to about 8.

The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, ethylene diamine tetraacetic acid (EDTA) may be added to help adjust the pH to the desired values noted above.

### Shell Resin

In embodiments, after aggregation, but prior to coalescence, a resin coating may be applied to the aggregated particles to form a shell thereover. Any resin described above may be utilized as the shell. In embodiments, a polyester amorphous resin latex as described above may be included in the shell. In yet embodiments, the polyester amorphous resin latex described above may be combined with a different resin, and then added to the particles as a resin coating to form a shell.

Multiple resins may be utilized in any suitable amounts. In embodiments, a first amorphous polyester resin, for example an amorphous resin described above, may be present in an amount of from about 20 percent by weight to about 100 percent by weight of the total shell resin, in embodiments from about 30 percent by weight to about 90 percent by weight of the total shell resin. Thus, in embodiments, a second resin may be present in the shell resin in an amount of from about 0 percent by weight to about 80 percent by weight of the total shell resin, in embodiments from about 10 percent by weight to about 70 percent by weight of the shell resin.

The shell resin may be applied to the aggregated particles by any method within the purview of those skilled in the art. In embodiments, the resins utilized to form the shell may be in an emulsion including any surfactant described above. The emulsion possessing the resins, may be combined with the aggregated particles described above so that the shell forms over the aggregated particles.

The formation of the shell over the aggregated particles may occur while heating to a temperature of from about 30° C. to about 80° C., in embodiments from about 35° C. to about 70° C. The formation of the shell may take place for a period of time of from about 5 minutes to about 10 hours, in embodiments from about 10 minutes to about 5 hours.

### Coalescence

Following aggregation to the desired particle size and application of any optional shell, the particles may then be coalesced to the desired final shape, the coalescence being achieved by, for example, heating the mixture to a temperature of from about 45° C. to about 100° C., in embodiments from about 55° C. to about 99° C., at a pH from about 5 to about 10, in embodiments from about 6.5 to about 7.5, which may be at or above the glass transition temperature of the resins utilized to form the toner particles, and/or reducing the stirring, for example to from about 100 rpm to about 1,000 rpm, in embodiments from about 200 rpm to about 800 rpm. Coalescence may be accomplished over a period of from about 0.01 to about 9 hours, in embodiments from about 0.1 to about 4 hours.

After aggregation and/or coalescence, the mixture may be cooled to room temperature, such as from about 20° C. to about 25° C. The cooling may be rapid or slow, as desired. A suitable cooling method may include introducing cold water to a jacket around the reactor. After cooling, the toner particles may be optionally washed with water, and then dried. Drying may be accomplished by any suitable method for drying including, for example, freeze-drying.

### Additives

In embodiments, the toner particles may also contain other optional additives, as desired or required. For example, the toner may include positive or negative charge control agents, for example in an amount of from about 0.1 to about 10% by weight of the toner, in embodiments from about 1 to about 3% by weight of the toner. Examples of suitable charge control agents include quaternary ammonium compounds inclusive of alkyl pyridinium halides; bisulfates; alkyl pyridinium compounds, including those disclosed in U.S. Pat. No. 4,298,672, the disclosure of which is hereby incorporated by reference in its entirety; organic sulfate and sulfonate compositions, including those disclosed in U.S. Pat. No. 4,338,390, the disclosure of which is hereby incorporated by reference in its entirety; cetyl pyridinium tetrafluoroborates; distearyl dimethyl ammonium methyl sulfate; aluminum salts such as BONTRON E84™ or E88™ (Orient Chemical Industries, Ltd.); combinations thereof, and the like.

There can also be blended with the toner particles external additive particles after formation including flow aid additives, which additives may be present on the surface of the toner particles. Examples of these additives include metal oxides such as titanium oxide, silicon oxide, aluminum oxides, cerium oxides, tin oxide, mixtures thereof, and the like; colloidal and amorphous silicas, such as AEROSIL®, metal salts and metal salts of fatty acids inclusive of zinc stearate, calcium stearate, or long chain alcohols such as UNILIN 700, and mixtures thereof.

In general, silica may be applied to the toner surface for toner flow, triboelectric enhancement, admix control, improved development and transfer stability, and higher toner blocking temperature. TiO₂ may be applied for improved relative humidity (RH) stability, triboelectric control and improved development and transfer stability. Zinc stearate, calcium stearate and/or magnesium stearate may optionally also be used as an external additive for providing lubricating properties, developer conductivity, triboelectric enhancement, enabling higher toner charge and charge stability by increasing the number of contacts between toner and carrier particles. In embodiments, a commercially available zinc stearate known as Zinc Stearate L, obtained from Ferro Corporation, may be used. The external surface additives may be used with or without a coating.

Each of these external additives may be present in an amount of from about 0.1% by weight to about 5% by weight of the toner, in embodiments of from about 0.25% by weight to about 3% by weight of the toner, although the amount of additives can be outside of these ranges. In embodiments, the toners may include, for example, from about 0.1% by weight to about 5% by weight titania, from about 0.1% by weight to about 8% by weight silica, and from about 0.1% by weight to about 4% by weight zinc stearate.

Suitable additives include those disclosed in U.S. Pat. Nos. 3,590,000 and 6,214,507, the disclosures of each of which are hereby incorporated by reference in their entirety.

In accordance with the present disclosure, latexes produced with surfactants of the present disclosure, such as sodium lauryl sulfate, and processed via solvent-free extrusion routes overcome low parent particle charge problems that may be present with the use of other surfactants. In embodiments, the toners of the present disclosure may posses a final toner charge to diameter ratio (q/d) of from about −0.4 femtocoulombs per micron (fC/μm) to about −2 fC/μm, in embodiments from about −0.5 fC/μm to about −1.5 fC/μm. The toners of the present disclosure may posses a parent toner charge per mass ratio (q/m) of from about −10 microcoulombs per gram (μC/g) to about −80 μC/g, in embodiments from about −15 μC/g to about −45 μC/g.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Comparative Example 1

Control cyan toner with alkyldiphenyloxide disulfonate was prepared as follows.

A cyan polyester toner was prepared at 2 liter bench scale (150 grams dry theoretical toner). A toner slurry was utilized which included two amorphous polyester resin emulsions (at a ratio of about 70:30). One emulsion included about 176 grams of a low molecular weight resin having a Mw of about 18,000 daltons including an alkoxylated bisphenol A with terephthalic acid, fumaric acid, and dodecenylsuccinic acid co-monomers, and the other emulsion included about 61 grams of a high molecular weight resin having a Mw of about 85,000 daltons including alkoxylated bisphenol A with terephthalic acid, trimellitic acid, and dodecenylsuccinic acid co-monomers. About 2.2 parts per hundred (pph) of DOWFAX™ 2A1, an alkyldiphenyloxide disulfonate available commercially from The Dow Chemical Company was added to the combined emulsions. Then, added thereto was about 34 grams of a crystalline resin emulsion of the following formula:

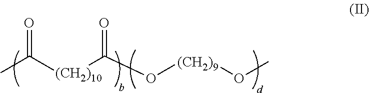

wherein b was from about 5 to about 2000 and d was from about 5 to about 2000, an additional 9.65 pph of DOWFAX™ 2A1, about 53 grams of cyan pigment, in a dispersion, and about 46 grams of a polyethylene wax (from IGI) in a dispersion. The components were mixed and then pH adjusted to 4.2 using 0.3M nitric acid.

The slurry was homogenized for about 5 minutes at a speed of from about 3,000 revolutions per minute (rpm) to about 4000 rpm while adding about 2.69 grams of aluminum sulfate as a coagulant and about 36 grams of deionized water (DIW). The toner slurry was then aggregated at about 460 rpm at a temperature of around 46° C. During aggregation, the toner particle size was closely monitored. At around 5 microns in size, a shell including the same amorphous emulsions as in the core (at the same ratio of 70:30) was added to achieve the final targeted particle size of from 5.8 to about 6.3 microns. Aggregation continued for about 30 minutes. The pH of the slurry was adjusted to about 7.8 using sodium hydroxide (NaOH) and VERSENE-100 ethylene diamine tetraacetic acid (EDTA) from the Dow Chemical Company was added to the slurry to freeze, i.e., stop, the aggregation of the toner particles.

The process proceeded with the reactor temperature (Tr) increased to achieve 85° C. Once the Tr reached 85° C., the pH of the toner slurry was reduced to about 6.5 using 0.3M nitric acid to begin the coalescence process. After the toner coalesced to form particles, the toner was cooled.

The toner had a volume average particle diameter of about 6.01 microns, a Volume Average Geometric Size Distribution (GSDv) of about 1.25, a Number Average Geometric Size Distribution (GSDn) of about 1.25, and a circularity of about 0.978. Fine particles, having an average particle diameter from about 1 micron to about 4 microns, were present in an amount of about 6.74% by weight of the toner, and coarse particles, those having an average particle diameter larger than about 16 microns, were present in an amount of about 0.17% by weight of the toner.

### Example 1

Toner with sodium lauryl sulfate was produced as follows using a solvent-free process.

A cyan polyester toner was prepared at 2 liter bench scale (150 grams dry theoretical toner). A toner slurry was utilized which included two amorphous polyester resin emulsions (at a ratio of about 50:50). One emulsion included about 103 grams of a low molecular weight resin having a Mw of about 18,000 daltons including an alkoxylated bisphenol A with terephthalic acid, fumaric acid, and dodecenylsuccinic acid co-monomers, and the other emulsion included about 99 grams of a high molecular weight resin having a Mw of about 85,000 daltons including alkoxylated bisphenol A with terephthalic acid, trimellitic acid, and dodecenylsuccinic acid co-monomers. About 2 pph of sodium lauryl sulfate was added to the slurry. Also added thereto was about 30 grams of a crystalline resin emulsion of the following formula:

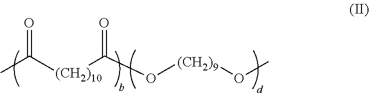

wherein b was from about 5 to about 2000 and d was from about 5 to about 2000, about 2 pph of DOWFAX™ 2A1, an alkyldiphenyloxide disulfonate available commercially from The Dow Chemical Company, about 53 grams of cyan pigment, in a dispersion, and about 46 grams of a polyethylene wax (from IGI) in a dispersion. The components were mixed and then pH adjusted to 4.2 using 0.3M nitric acid.

The slurry was homogenized for about 5 minutes at a speed from about 3,000 rpm to about 4000 rpm while adding about 2.69 grams of aluminum sulfate as a coagulant and about 36 grams of deionized water (DIW). The toner slurry was then aggregated at about 460 rpm at a temperature of around 45° C. During aggregation, the toner particle size was closely monitored. At around 4.8 microns in size, a shell including the same amorphous emulsion as in the core (ratio 50:50) was added to achieve the final targeted particle size of from about 5.6 to about 5.8 microns. Aggregation continued for about 30 minutes. The pH of the slurry was adjusted to about 7.8 using sodium hydroxide (NaOH) and VERSENE-100 (EDTA) from the Dow Chemical Company was added to the slurry to freeze, i.e., stop, the aggregation of the toner particles.

The process proceeded with the Tr increased to achieve 85° C. Once the Tr reached 85° C., the pH of the toner slurry was reduced to about 7 using 0.3M nitric acid to begin the coalescence process. After the toner coalesced to form particles, the toner was cooled.

The toner had a volume average particle diameter of about 6.28 microns, a GSDv of about 1.22, a GSDn of about 1.25, and a circularity of about 0.974. Fine particles, having an average particle diameter from about 1 micron to about 4 microns, were present in an amount of about 8.41% by weight of the toner, and coarse particles, those having an average particle diameter larger than about 16 microns, were present in an amount of about 0.35% by weight of the toner.

### Charging

Toner charging. Developers were prepared by adding about 0.5 grams of the toners of Comparative Example 1 and Example 1 to about 10 grams of Xerox WCP3545 production carrier. Three developer samples were prepared for each toner evaluated. One sample was conditioned overnight in A-zone (28° C./85% relative humidity (RH)), another was conditioned overnight in B-zone (21° C./50% RH), and the other was conditioned overnight in the C-zone (10° C./15% RH). The next day, the developer samples were sealed and agitated for about 2 minutes and then for about 1 hour using a Turbula mixer. After mixing, the triboelectric charge of the toner was measured using a charge spectrograph with a 100 V/cm field. The toner charge (q/d) was measured visually as the midpoint of the toner charge distribution. The charge was reported in millimeters of displacement from the zero line (mm displacement can be converted to femtocoulombs/micron (fC/μm) by multiplying by 0.092). The parent toner charge per mass ratio (q/m) was also measured in micro coulombs per gram (μC/g) using a spectrograph.

Following about 1 hour of mixing, an additional 0.5 grams of toner was added to the already charged developer, and mixed for an additional 15 seconds, where a q/d displacement was again measured, and then mixed for an additional 45 seconds (total 1 minute of mixing), and again a q/d displacement was measured. Table 1 shows charge characteristics of the toners of Comparative Example 1 and Example 1 in A, B and C-zones. The toner of the Examples showed a slight improvement in parent particle triboelectric charge, which may be attributed to the use of silica.

TABLE 1

| | | | B-Zone | | | |
|---|---|---|---|---|---|---|
| | A-Zone | | parent | | C-Zone | |
| Toner ID | q/d | q/m | q/d | q/m | q/d | q/m |
| Comparative Example 1 | 8.8 | 38 | 15.5 | 78 | 16.8 | 80 |
| Example 1 | 7.6 | 49 | 20.3 | 110 | 15.9 | 80 |

q/d is in femtocoulombs per micron (fC/μm)
q/m is in microcoulombs per gram (μC/g)

### Fusing

The toners of Example 1 and the Comparative Example 1 were submitted for fusing evaluation. Fusing performance (gloss, crease, and hot offset measurements) of particles was collected.

All unfused images were generated using a modified DC12 copier from Xerox Corporation. A TMA (Toner Mass per unit Area) of 1.00 mg/cm² of each toner was made on Color Xpressions+ paper (90 gsm, uncoated) (sometimes referred to as CX+ paper), using a commercially available fusing fixture. Gloss/crease targets were a square image placed in the center of the page.

Process speed of the fuser was set to 220 mm/second (nip dwell of about 34 miliseconds) and the fuser roll temperature was varied from cold offset to hot offset or up to about 210° C. for gloss and crease measurements.

Crease area measurements were carried out with an image analysis system. Print gloss as a function of fuser roll temperature was measured with a BYK Gardner 75° gloss meter. A summary of the fusing results is reported in Table 2 below. Gloss at 185° C., fusing latitude, and the minimum fusing temperature (MFT) is reported.

TABLE 2

| | | Toner of |
|---|---|---|
| | Toner of | Comparative |
| | Example 1 | Example 1 |
| Cold offset on CX+ | 120 | 123 |
| Gloss at MFT on CX+ | 26.5 | 21.3 |
| Gloss at 185° C. on CX+ | 63.2 | 61.5 |
| Peak Gloss on CX+ | 68.2 | 61.9 |
| T (Gloss 50) on CX+ | 142 | 153 |
| T (Gloss 60) on CX+ | 153 | 171 |
| MFT_{CA=80} (extrapolated MFT) | 121 | 124 |
| ΔMFT (EA/SA-40° C.) (relative to a | −29 | −30 |
| conventional EA toner using the same resins | | |
| fused the same day) | | |
| Mottle/Hot Offset CX+ 220 mm/s | >185/>190 | >200/>210 |
| Fusing Latitude | >69 | >69 |
| HO-MFT on DCX+ (>50) | | |
| ΔFix (T_{G50} & MFT_{CA=80}) | −23 | −16 |
| 24 hour @ 60° C. Document Offset Toner- | 4.00/1.00 | 4.50/2.00 |
| Toner/Toner-Paper (rmsLA % voide) | 0.002/4.2% | 0.002/1.4% |

CX+ = paper utilized from Xerox Corporation
MFT = minimum fusing temperature
Fusing Latitude = Hot Offset − MFT on CX+ paper
Δfix is the minimum fusing temperature required to reach 50 gloss units or a crease fix area of 80 relative to some control toner.
24-hour @ 60° C. Document Offset Toner = amount of Toner to toner and toner to paper document offset test conducted at 60° C./80 g/cm²/50% R.H.
ΔMFT (EA/SA-40° C.) = minimum fixing temperature in reference to a styrene-acrylate emulsion aggregation type toner
Mottle/Hot Offset = the temperature at which the toner will lift off the paper and stick to the fuser roll
T (Gloss 50) = temperature at which the toner reaches 50 gloss units
T (Gloss 60) = temperature at which the toner reaches 60 gloss units

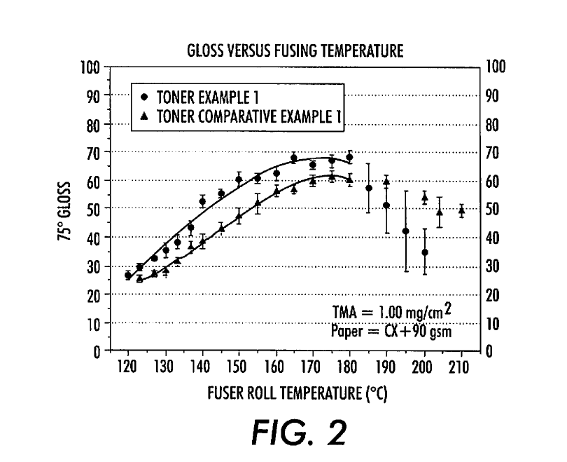

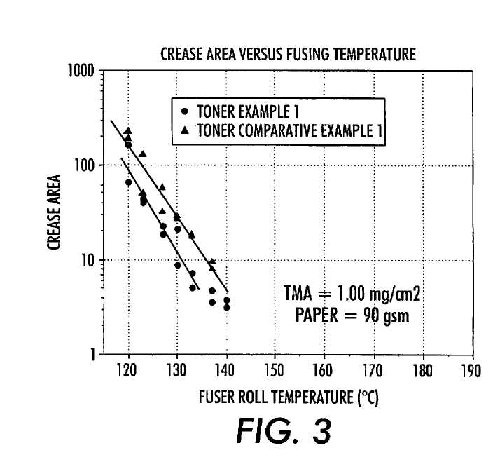

FIGS. 2 and 3 are graphs depicting gloss and crease area, respectively, as a function of fusing temperature of the toner of Example 1 produced with sodium lauryl sulfate in accordance with the present disclosure, compared with the control toner of Comparative Example 1 lacking the sodium lauryl sulfate treatment as a control. As seen from the data of Tables 1 and 2 above and the graphs of FIGS. 2 and 3, neither charging nor fusing showed significant difference due to the presence of sodium lauryl sulfate.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A process comprising:
forming a pre-blend mixture by optionally contacting at least one amorphous polyester resin with an optional plasticizer;
neutralizing the pre-blend mixture with a neutralizing agent to form a neutralized pre-blend mixture;
contacting the neutralized pre-blend mixture with a surfactant selected from the group consisting of alkyl sulfates, alkyl ether sulfates, and combinations thereof;
melt-mixing the pre-blend mixture;
contacting the melt-mixed mixture with de-ionized water to form an oil in water emulsion possessing a latex; and
recovering the latex.

2. The process according to claim 1, wherein the at least one amorphous polyester resin comprises an alkoxylated bisphenol A fumarate/terephthalate based polyester or copolyester resin.

3. The process according to claim 1, further comprising:
contacting the latex with a crystalline resin, an optional colorant, and an optional wax to form a second mixture;
aggregating the mixture to form particles;
adjusting the pH of the mixture to from about 6.8 to about 8 to stop growth of the particles;
coalescing the particles at a pH from about 6.5 to about 7.5 to form toner particles; and
recovering the toner particles,
wherein the toner particles possess a final charge per mass ratio of from about −10 microcoulomb per gram to about −80 microcoulombs per gram, and wherein the at least one crystalline polyester resin comprises 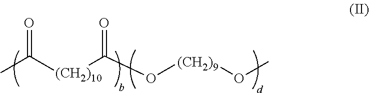
wherein b is from about 5 to about 2000 and d is from about 5 to about 2000.

4. The process according to claim 1, wherein the neutralizing agent comprises a solid neutralizing agent selected from the group consisting of ammonium hydroxide, potassium hydroxide, sodium hydroxide, sodium carbonate, sodium bicarbonate, lithium hydroxide, potassium carbonate, potassium bicarbonate, and combinations thereof, at a concentration of from about 0.2% by weight to 5% by weight of the at least one polyester resin, and wherein the neutralizing agent raises the pH of the pre-blend mixture to from about 5 to about 12.

5. The process according to claim 1, wherein the neutralizing agent comprises primary and secondary aliphatic and aromatic amines selected from the group consisting of aziridines, azetidines, piperazines, piperidines, pyridines, bipyridines, terpyridines, dihydropyridines, morpholines, N-alkylmorpholines, 1,4-diazabicyclo[2.2.2]octanes, 1,8-diazabicycloundecanes, 1,8-diazabicycloundecenes, dimethylated pentylamines, trimethylated pentylamines, pyrimidines, pyrroles, pyrrolidines, pyrrolidinones, indoles, indolines, indanones, benzindazones, imidazoles, benzimidazoles, imidazolones, imidazolines, oxazoles, isoxazoles, oxazolines, oxadiazoles, thiadiazoles, carbazoles, quinolines, isoquinolines, naphthyridines, triazines, triazoles, tetrazoles, pyrazoles, pyrazolines, and combinations thereof, at a concentration of from about 0.2% by weight to 5% by weight of the at least one polyester resin, and wherein the neutralizing agent raises the pH of the pre-blend mixture to from about 5 to about 12.

6. The process according to claim 1, wherein the surfactant is present in an amount of from about 1% to about 15% by weight of the at least one amorphous polyester resin.

7. The process according to claim 1, wherein the alkyl sulfates are selected from the group consisting of sodium hexyl sulfate, sodium octyl sulfate, sodium decyl sulfate, sodium dodecyl sulfate, sodium tridecyl sulfate, sodium tertadecyl sulfate, sodium hexadecyl sulfate, sodium octyl decyl sulfate, sodium lauryl sulfate, sodium myristyl sulfate, sodium palmityl sulfate, sodium stearyl sulfate, sodium oleylic sulfate, and combinations thereof.

8. The process according to claim 1, wherein the alkyl ether sulfates are selected from the group consisting of sodium hexyl ether sulfate, sodium octyl ether sulfate, sodium decyl ether sulfate, sodium dodecyl ether sulfate, sodium tridecyl ether sulfate, sodium tertadecyl ether sulfate, sodium hexadecyl ether sulfate, sodium octyl decyl ether sulfate, sodium laureth sulfate, sodium myreth sulfate, sodium palmeth sulfate, sodium pareth sulfate, sodium steareth sulfate, sodium oleyl ether sulfate, and combinations thereof.

9. A process comprising:
forming a resin mixture by optionally contacting at least one amorphous polyester resin with an optional plasticizer in a first section of an extruder;
neutralizing the resin mixture in a second section of the extruder with a neutralizing agent to form a neutralized resin mixture;
contacting the neutralized resin mixture with a surfactant in the extruder, the surfactant selected from the group consisting of alkyl sulfates, alkyl ether sulfates, and combinations thereof;
melt-mixing the resin mixture in the extruder;
contacting the melt-mixed mixture with de-ionized water to form an oil in water emulsion in the extruder;
recovering the emulsion from the extruder;
contacting the emulsion with an optional crystalline resin, an optional colorant, and an optional wax to form a second mixture;
aggregating the mixture to form particles;
adjusting the pH of the mixture to from about 6.8 to about 8 to stop growth of the particles;
coalescing the particles at a pH from about 6.5 to about 7.5 to form toner particles; and
recovering the toner particles.

10. (canceled)

11. The process according to claim 9, wherein the neutralizing agent comprises a solid neutralizing agent selected from the group consisting of ammonium hydroxide, potassium hydroxide, sodium hydroxide, sodium carbonate, sodium bicarbonate, lithium hydroxide, potassium carbonate; potassium bicarbonate, and combinations thereof, at a concentration of from about 0.2% by weight to 5% by weight of the at least one polyester resin, and wherein the neutralizing agent raises the pH of the resin mixture to from about 5 to about 12.

12. The process according to claim 9, wherein the neutralizing agent comprises primary and secondary aliphatic and aromatic amines selected from the group consisting of aziridines, azetidines, piperazines, piperidines, pyridines, bipyridines, terpyridines, dihydropyridines, morpholines, N-alkylmorpholines, 1,4-diazabicyclo[2.2.2]octanes, 1,8-diazabicycloundecanes, 1,8-diazabicycloundecenes, dimethylated pentylamines, trimethylated pentylamines, pyrimidines, pyrroles, pyrrolidines, pyrrolidinones, indoles, indolines, indanones, benzindazones, imidazoles, benzimidazoles, imidazolones, imidazolines, oxazoles, isoxazoles, oxazolines, oxadiazoles, thiadiazoles, carbazoles, quinolines, isoquinolines, naphthyridines, triazines, triazoles, tetrazoles, pyrazoles, pyrazolines, and combinations thereof, at a concentration of from about 0.2% by weight to 5% by weight of the at least one polyester resin, and wherein the neutralizing agent raises the pH of the resin mixture to from about 5 to about 12.

13. (canceled)

14. (canceled)

15. A process comprising:
forming a resin mixture by contacting at least one polyester resin with an optional crystalline resin and an optional plasticizer in an extruder;
neutralizing the resin mixture in the extruder with a neutralizing agent to form a neutralized resin mixture;
contacting the neutralized resin mixture in the extruder with a surfactant selected from the group consisting of sodium hexyl sulfate, sodium octyl sulfate, sodium decyl sulfate, sodium dodecyl sulfate, sodium tridecyl sulfate, sodium tertadecyl sulfate, sodium hexadecyl sulfate, sodium octyl decyl sulfate, sodium lauryl sulfate, sodium myristyl sulfate, sodium palmityl sulfate, sodium stearyl sulfate, sodium oleylic sulfate, sodium hexyl ether sulfate, sodium octyl ether sulfate, sodium decyl ether sulfate, sodium dodecyl ether sulfate, sodium tridecyl ether sulfate, sodium tertadecyl ether sulfate, sodium hexadecyl ether sulfate, sodium octyl decyl ether sulfate, sodium laureth sulfate, sodium myreth sulfate, sodium palmeth sulfate, sodium pareth sulfate, sodium steareth sulfate, sodium oleyl ether sulfate, and combinations thereof;
melt-mixing the resin mixture in the extruder;
contacting the melt-mixed mixture with de-ionized water in the extruder to form an oil in water emulsion;
recovering the emulsion from the extruder;
contacting the emulsion with an optional crystalline resin, an optional colorant, and an optional wax to form a second mixture;
aggregating the mixture to form particles;
adjusting the pH of the mixture to from about 6.8 to about 8 to stop growth of the particles;
coalescing the particles at a pH from about 6.5 to about 7.5 to form toner particles; and
recovering the toner particles.

16. The process according to claim 15, wherein the surfactant is present in an amount of from about 1% to about 15% by weight of the at least one amorphous polyester resin.

17. The process according to claim 15, wherein the surfactant is present in an amount of from about 2% to about 10% by weight of the at least one amorphous polyester resin and the de-ionized water is added so that the emulsion possesses a solid content of from about 20% to about 50%.

18. The process according to claim 15, wherein the neutralizing agent is selected from the group consisting of ammonium hydroxide, potassium hydroxide, sodium hydroxide, sodium carbonate, sodium bicarbonate, lithium hydroxide, potassium carbonate, and combinations thereof, and raises the pH of the resin mixture to from about 5 to about 12.

19. The process according to claim 15, wherein the neutralizing agent comprises primary and secondary aliphatic and aromatic amines selected from the group consisting of aziridines, azetidines, piperazines, piperidines, pyridines, bipyridines, terpyridines, dihydropyridines, morpholines, N-alkylmorpholines, 1,4-diazabicyclo[2.2.2]octanes, 1,8-diazabicycloundecanes, 1,8-diazabicycloundecenes, dimethylated pentylamines, trimethylated pentylamines, pyrimidines, pyrroles, pyrrolidines, pyrrolidinones, indoles, indolines, indanones, benzindazones, imidazoles, benzimidazoles, imidazolones, imidazolines, oxazoles, isoxazoles, oxazolines, oxadiazoles, thiadiazoles, carbazoles, quinolines, isoquinolines, naphthyridines, triazines, triazoles, tetrazoles, pyrazoles, pyrazolines, and combinations thereof, at a concentration of from about 0.2% by weight to 5% by weight of the at least one polyester resin, and wherein the neutralizing agent raises the pH of the resin mixture to from about 5 to about 12.

20. The process according to claim 15, wherein the toner particles possess a final charge per mass ratio from about −10 microcoulombs per gram to about −80 microcoulombs per gram.

21. The process of claim 1, occurring in an extruder.

22. The process of claim 1, further comprising contacting said latex, with an optional wax and an optional colorant to form a second mixture and recovering toner particles from said second mixture.

23. The process of claim 1, wherein said pre-blend mixture comprises a crystalline resin.
